(19) United States
(12) Patent Application Publication
(10) Pub. No.: US 2014/0348044 A1
(43) Pub. Date: Nov. 27, 2014

(54) Real-Time Rich Communications Client Architecture

(71) Applicant: Ecrio, Inc., Cupertino, CA (US)

(72) Inventors: Krishnakumar Narayanan, Pleasanton, CA (US); Michel E. Gannage, Los Altos Hills, CA (US)

(73) Assignee: ECRIO, INC., Cupertino, CA (US)

(21) Appl. No.: 14/284,136

(22) Filed: May 21, 2014

Related U.S. Application Data
(60) Provisional application No. 61/826,017, filed on May 21, 2013.

(51) Int. Cl. H04L 29/06

(52) U.S. Cl. CPC H04L 65/608; H04L 65/1023; H04L 65/1016
USPC 370/310

(57) ABSTRACT

A distributed services modular client architecture may be used to implement IP-based real time rich communication (“RTC”) services with any type of RTC-enabled digital device and a virtual RTC client on the cloud. The services may be distributed among the RTC-enabled digital device and the virtual RTC client. The architecture may distribute signaling and medial exchange plane functions among the RTC-enabled digital device and the virtual RTC client. The architecture may use a SIP/IMS framework, and may be modularized by placing certain services into their own framework so that a particular service may be plugged into the SIP/IMS framework or omitted. The frameworks may be installed in a virtual machine in the cloud, or divided between the device and the virtual machine, depending upon the device capabilities and to allow optimal media processing and transport. Some of the frameworks may be replicated on both the device and the virtual machine.

### CROSS-REFERENCE TO RELATED APPLICATIONS

This application claims the benefit of U.S. Provisional Patent Application Ser. No. 61/826,017 filed May 21, 2013, which hereby is incorporated herein in its entirety by reference thereto.

### BACKGROUND OF THE INVENTION

1. Field of the Invention

This invention relates generally to rich communications methods and devices, and more particularly to a real-time rich communications client architecture for various Internet Protocol networks such as 4G/LTE, Wi-Fi, WiMAX and 3G networks.

2. Description of the Related Art

Many different types of digital electronic devices require a rich communications capability. The number and type of devices has grown dramatically, and each device category, manufacturer, and service may have a wide range of device platforms and operating systems, and multiple application environments, and are required to interoperate across many networks and systems. Since applications typically are device and service specific, this has limited the availability and use of new functions and capabilities to selected devices. The time and investment required to implement a new capability across an entire, complex device portfolio continues to increase as the range and type of devices increases. Developers, device suppliers, and service providers need a better means to support many device types and models with lower incremental time, cost, and risk to fully utilize investments and to offer services and value to more customers and markets.

Long Term Evolution (“LTE”) is a relatively recent standard developed by the Third Generation Partnership Project (“3GPP”) for wireless communication of high speed data for mobile phones and data terminals. Voice over LTE (“VoLTE”) has become the preferred industry choice for providing voice services over LTE. However, implementation of LTE on digital electronic devices has been hindered by power consumption issues and, in the case of VoLTE, long implementation lead times.

### BRIEF SUMMARY OF THE INVENTION

One embodiment of the present invention is a real-time rich communications (“RTC”) client architecture for rich communication services over the cloud, comprising: a virtual real time communications client (“virtual RTC client”) on the cloud; and a real time rich communications enabled digital device (“RTC-enabled digital device”) comprising at least one processor and digital memory, and further comprising software components stored in the digital memory and executable by the processor to enable real time signaling via the virtual RTC client.

Another embodiment of the present invention is a virtual client on the cloud for supporting real-time rich communications (“RTC”) services over the cloud, the client comprising a virtual real time communications client (“virtual RTC client”) configured to communicate with a real time rich communications enabled digital device to enable real time internet protocol (“IP”) signaling services through the cloud.

Another embodiment of the present invention is a method for providing real-time rich communications over the cloud, comprising establishing a signaling plane via a virtual real time communications client (“virtual RTC client”) on the cloud with a RTC-enabled digital device, the RTC-enabled digital device comprising at least one processor and digital memory, and further comprising software components stored in the digital memory and executable by the processor to enable real time signaling via the virtual RTC client.

### BRIEF DESCRIPTION OF THE SEVERAL VIEWS OF THE DRAWINGS

FIG. 1 is a schematic diagram of a LTE device chipset or SoC device.

FIG. 2 is a schematic diagram of an abstraction model of client architecture for an illustrative implementation of VoIP, Video, RCS and SMS features.

FIG. 3 is a schematic diagram of a client-server system architecture for rich communications between a WebRTC client and an embedded client.

FIG. 4 is a schematic diagram of a client-server system architecture for rich communications between a plurality of WebRTC clients.

FIG. 5 is a schematic diagram of a client-server system architecture for rich communications between a plurality of WebRTC clients, which includes cloud-based data processing functions.

FIG. 6 is a schematic block diagram showing an illustrative distribution of frameworks based on RTC function.

FIG. 7 is a schematic block diagram showing another illustrative distribution of frameworks based on RTC service type.

FIG. 8 is a schematic block diagram showing another illustrative distribution of frameworks based on RTC function.

FIG. 9 is a schematic block diagram showing another illustrative distribution of frameworks based on RTC service type.

FIG. 10 is a schematic block diagram of a client-server system architecture for rich communications between various RTC-enabled digital devices, including distributed and embedded clients.

### DETAILED DESCRIPTION OF THE INVENTION, INCLUDING THE BEST MODE

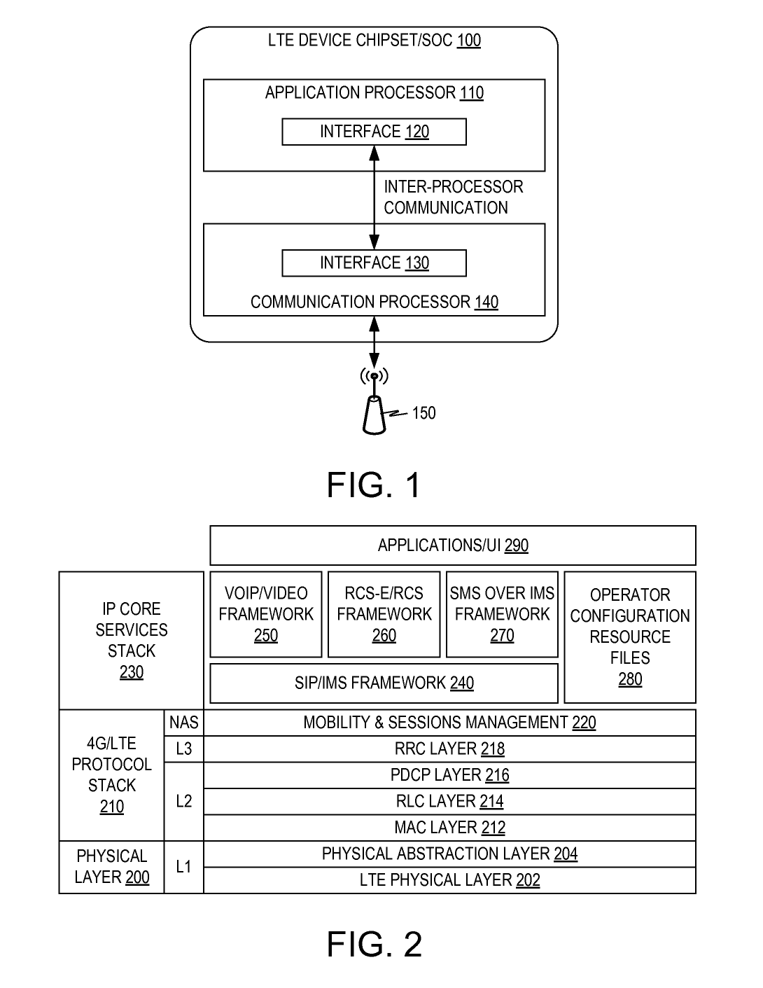

Real-time rich communications (“RTC”) over various Internet Protocol (“IP”) networks such as 4G/LTE, Wi-Fi, WiMAX and 3G is desirable for many different types of RTC-enabled digital devices, including mobile digital devices such as, for example, smartphones, feature phones, tablets, and ultrabooks and other laptops, and embedded devices such as, for example, machine-to-machine (“M2M”) digital devices which are used in such applications as manufacturing, monitoring, telematics, healthcare, utilities, home automation, and in-vehicle entertainment. Such real-time rich communications may be implemented using single processors (single or multiple core), multiple-processor chip sets, or systems-on-chip. FIG. 1 shows an illustrative chip set / System-on-Chip (“SoC”) 100 which includes a communication processor 140, illustratively a modem/baseband processor, for example, for handling network operations, and an application processor 110 for running various user applications. Implemented with limited functionality, the communication processor 140 may have lower power consumption than the application processor 110. An interface 120 in the application processor 110 and an interface 130 in the communication processor 140 facilitate inter-processor communication.

Processors, chip sets, and systems-on-chip suitable for rich communications via IP networks, including, for example, 4G/LTE, Wi-Fi, WiMAX and 3G, are quite varied. The relative processing power and power consumption of the application processor 110, or of its cores if a multicore processor, and the communication processor 140 may vary substantially from chip set to chip set, as may the particular implementations of the application processor 110 and the communication processor 140. The application processor 110, for example, may be single core or multi-core (dual core or quad core, for example). If multi-core, the various cores may be optimized for different purposes; for example, low latency, high quality of service, and low power consumption through either low power dissipation or aggressive power management. A given chip set may have one communication processor suitable for several rich communications protocols, or multiple simple communication processors each specializing in a particular rich communications protocol.

While custom real-time rich communications client architectures may be developed for such chip sets, we have found that a distributed services modular client architecture may be used to implement IP-based real time rich communication services, including VoLTE, video calling, and companion rich communications services (“RCS”), in a flexible manner among a wide variety of different types of processors, chip sets, systems-on-chip, and cloud resources.

In one example of such a client architecture, the various services, which may also be referred to as functions, may be distributed among two or more processor cores in accordance with a number of factors, including power requirements, media latency, quality of service, and any other considerations as may be desired. Such a client architecture is described in U.S. Pat. No. 8,639,253 issued Jan. 28, 2014 to Narayanan et al. and entitled “Real-Time Communications Client Architecture,” which hereby is incorporated herein in its entirety by reference thereto. The client architecture uses a modular SIP/IMS framework with other other services being placed into their own modular frameworks as well, so that a particular service framework may be plugged into the SIP/IMS framework if and when desired, and otherwise omitted. The frameworks may be installed on various processor cores within the chip set or system-on-chip based on their power demands and profiles, media latency constraints, and quality of service constraints.

Alternatively, or in addition, a distributed services modular client architecture may be used to implement IP-based real time rich communication services in a flexible manner with any type of RTC-enabled digital device having one or more processor cores and a virtual RTC client on the cloud. The various services may be distributed among the RTC-enabled digital device and the virtual RTC client, in accordance with a number of factors, including power consumption, media latency, on-time, performance and other considerations. The modular client architecture may also distribute signaling and media exchange plane functions among the RTC-enabled digital device and the virtual RTC client in the cloud. The distribution of these functions may be in accordance with a number of factors, including capturing media data, encode, send network, receive from network, decode, playback functions optimally done at the device, and other considerations. The modular client architecture may use a SIP/IMS framework, and may be modularized by placing certain services into their own framework so that a particular service may be plugged into the SIP/IMS framework if and when desired, and otherwise omitted. The frameworks may be installed in a virtual machine in the cloud, or divided between the device and a virtual machine in the cloud, depending upon the device capabilities and to allow optimal media processing and transport. Some of the frameworks may be replicated on both the device and the virtual machine in the cloud. Depending upon device and cloud load conditions, among other considerations, the frameworks in the device and/or in the cloud may be turned On or Off for load balancing and optimal real time rich communication services. Frameworks installed on the device may be installed as described in U.S. Pat. No. 8,639,253 issued Jan. 28, 2014 to Narayanan et al. and entitled “Real-Time Communications Client Architecture,” which hereby is incorporated herein in its entirety by reference thereto.

As used herein, the term “real time rich communications” refers to rich communications having a latency generally within acceptable norms for the rich communications application in question, in that any perceptible delay between the sender and the receiver are minimal and tolerated. In the case of VoIP, for example, the latency generally should not exceed about 150 ms.

As used herein, the term “device platform environment” refers to hardware, operating system, frameworks, and combinations thereof created for a device platform.

As used herein, the term “rich communication” refers to various (one or more in any combination) service capabilities including, but not limited to: (a) voice calling, including standard voice, Voice over IP calling over IMS, and Voice over LTE; (b) Short Message Service (“SMS”) over IP Messaging over IMS; (c) packet switched video telephony including two-way video calling; (d) situation awareness, including real-time presence, capabilities, and location for contacts; (e) enhanced messaging, including both standard and advanced IP messaging including conversational messaging; and (f) sharing, including real-time, person-to-person video, image, and file sharing.

As used herein, the term “framework” refers to a collection of one or more software components such as application logic controllers (“ALC”), engines, enablers, and protocol stacks for carrying out one or more functions. A framework may but need not contain all of the components needed for carrying out its function, provided it has access to the absent components. Components such as engines and enablers, for example, may be provided outside of the framework through extensions so that they may be shared, or direct function calls from an ALC without sharing.

As used herein, the term “communication processor” or “CP” refers to a chip or part of a chip that manages various radio functions in a network interface. Such a processor may include its own memory such as, for example, random access memory, and may use its own operating system, typically a simple real time operating system (“RTOS”) written in firmware. Suitable operating systems include, for example, the Real-Time Executive (“REX”) operating system available from Qualcomm Incorporated of San Diego, Calif., USA, and the Nucleus operating system available from Mentor Graphics Corporation of Wilsonville, Oreg., USA. While software may be installed on a communication processor in any manner desired, including random access memory (“RAM”), Flash, and other types of memory, a particularly advantageous manner of installation when low power operation is desired is to embed the software as read-only memory (“ROM”) during the manufacturing process.

As used herein, the term “application processor” or “AP” refers to a chip or part of a chip that runs various user and manufacturer applications under relatively powerful and sophisticated operating systems. Such a processor may include its own memory. In the case of mobile phones, for example, suitable application processor architectures include the Advanced RISC Machine (“ARM”) architecture and various architectures available from Intel Corporation of Santa Clara, Calif., USA. Suitable operating systems include, for example, the Android and Linux operating systems which are available from various companies, the Windows(R) operating system available from Microsoft Corporation of Redmond, Wash., USA, and the iOS operating system available from Apple Inc. of Cupertino, Calif., USA.

As used herein, the term “chipset” refers to a group of integrated circuit chips that are designed to function together and are usually marketed as a single product. The chips themselves may be separately packaged, or packaged together in a unifying substrate for use as a single component, as in the case of a multi-chip module, for example. Communication between the application processor and communication processor may be through respective fast interfaces which are usually dependent on the chipset manufacturer.

As used herein, the term “System-on-Chip” or SoC refers to a chip which contains various different types of circuits. In the case of mobile phones, for example, a SoC may integrate an ARM microprocessor core along with a communication processor, a graphical processing unit, and random access memory. Communication between the application processor and communication processor may be through respective fast interfaces which are usually dependent on the SoC manufacturer.

As used herein, the term “multicore processor” refers to a single computing component having two or more essentially independent processors, or cores, for the reading and execution of program instructions. Many options striking various balances between power requirements and performance characteristics are available. ARM Ltd. of Cambridge, UK, offers big.LITTLE processing using the performance ability of the ARM CORTEX-A15 MPCORE™ processor with the energy efficiency of the Cortex-A7 processor, and features fast switching between the two to conserve power when the workload is reduced. NVIDIA Corporation of Santa Clara, Calif., USA, offers a Variable SMP technology using multiple Cortex-A9 cores along with a special “battery saver” core which can be quickly switched to when the workload is reduced. Texas Instruments Incorporated of Dallas, Tex., USA, offers the OMAP™ 5 platform with two Cortex-A15 high performance cores and two Cortex-M4 low power cores, and the SMARTREFLEX™ 3 technologies which help reduce power consumption by adapting voltage and frequency based on device activity. A multi-core processor may also include one or more cores implemented as one or more communication processors. A communication processor may also have multiple cores.

As used herein, the term “processor core” may, for example, refer to a single core processor as well as a core of a multicore processor. One or more of the cores in a multicore processor may be a low power core, which also is referred to as a battery saver core.

As used herein, the term “application programming interface” or API refers to a set of routines, data structures, object classes and/or protocols provided by libraries and/or operating system services in order to support the building of applications.

As used herein, the term “modular” refers to a software component which generally accomplishes a specific function in a generally self-contained manner, with clear logical boundaries representing a separation of concerns relative to other modules. A module's interface expresses the elements which are provided and required by the module, and the elements defined in the interface may be detectable by other modules. Communication between modules via their interfaces may be done using message passing or call interfacing, for example.

As used herein, the term “cloud” refers to a collection of shared computing resources, both hardware and software, which are available from remote locations over various networks such as the internet, operator networks, enterprise networks, and social networks.

FIG. 2 is a schematic diagram of an illustrative abstraction model of client architecture for real-time IP rich communications. While the abstraction model focuses on 4G/LTE, is it in principle applicable to other types of IP networks such as Wi-Fi, WiMAX and 3G. At the radio interface, the model is shown as a three layer protocol stack. The physical layer L1 (200) includes a LTE physical sublayer 202 and a physical abstraction sublayer 204. A 4G/LTE protocol stack 210 is shown in two layers L2 and L3. Layer L2 includes a Media Access Control (“MAC”) sublayer 212, a Radio Link Control (“RLC”) sublayer 214, and a Packet Data Convergence Protocol (“PDCP”) sub layer 216. Layer L3 includes a Radio Resource Control (“RRC”) sub layer 218. Operating over layers L1, L2 and L3 is the Mobility and Session Management or Non-Access Stratum (“NAS”) layer. The protocol stacks L1, L2, L3 and NAS constitute a 4G/LTE modem.

An IP core services stack 230 operates outside of the radio interface, and includes core services such as a SIP/IMS framework 240, Voice over IP (“VoIP”)/Video framework 250, RCS-e/RCS framework 260, and SMS over IMS framework 270. The frameworks 250, 260 and 270 are modular and plug into the SIP/IMS framework 240, which also is modular. Other frameworks (not shown) may be prepared and plugged into the SIP/IMS framework 240 as well. The SIP/IMS framework 240 for the Internet Protocol Multimedia Subsystem (“IMS”) may be a standardized architecture which uses a Voice-over-IP (“VoIP”) implementation based on a 3GPP standardized implementation of the Session Initiation Protocol (“SIP”), and runs over the open standard IP protocols. Existing phone systems (both packet-switched and circuit-switched) are supported. The SIP/IMS framework 240 may include protocol stacks, an application controller, a start-up engine, and a user agent engine. The voice/video framework 250 may include a VoIP engine, supplemental services, high definition voice, and video calling, and may be IR 92 compliant. The RCS-e/RCS framework 260 may include a presence engine, IP messaging engine, contact and group engine, file transfer engine, and a video share engine. The SMS over IMS framework also may be IR 92 compliant.

The SIP/IMS framework 240 contains a collection of software components which may include, for example, engines such as SIP User Agent and IMS Startup, and enablers such as IMS Library, SIP, SigComp, Presence, XDM, MSRP, RTP, RTCP. Enablers. SIP, RTP, RTCP and MSRP are also protocol stacks—SIP enabler implements SIP Protocol Stack, RTP enabler implements RTP Protocol Stack, RTCP enabler implements RTCP Protocol Stack, and MSRP enabler implements MSRP Protocol Stack.

The VoIP/Video framework 250 contains a collection of software components such as a VoIP ALC and a Video ALC. This framework implements functions such as one-to-one voice call over IP network, multi-party conference calls, and associated supplementary features such as call hold, call mute, and so forth. Functions may be defined by popular industry forums such as GSMA, 3GPP, OMA, IETF, and may be customized by service providers or other vendors in the ecosystem.

The RCS-e/RCS framework 260 contains a collection of software components such as a RCS-e ALC and a RCS ALC. This framework implements functions such as Instant Messaging, one-to-one or multi-party chats, presence, video sharing, image sharing and file transfer. Functions may be defined by popular industry forums such as GSMA, 3GPP, OMA, IETF, and may be customized by service providers or other vendors in the ecosystem.

The SMS over IMS framework 270 contains a collection of software components such as a SMS ALC. This framework implements functions such as sending and receiving SMS messages over IP network. Functions may be defined by popular industry forums such as GSMA, 3GPP, OMA, IETF, and may be customized by service providers or other vendors in the ecosystem.

The frameworks may be divided or combined if desired, and some elements of a framework may be moved to other frameworks and even to other processor cores. The VoIP/Video framework 250, for example, may be divided into a VoIP framework and a Video framework, if desired. However, care is needed to avoid degradation in performance and quality of the functions provided by the framework.

Operator configuration resource files 280 are customized for each operator and are provided for such parameters as custom timer values, domain names, compression and security parameters, and so forth.

Applications and user interface 290 operates over the frameworks 250, 260 and 270. The user interface may be prepared by the original equipment manufacturer, while the applications may be prepared by the original equipment manufacturer or by third parties.

Advantageously, the core service frameworks may be distributed among the RTC-enabled digital device and and a virtual RTC client in the cloud to achieve a desired balance of power conservation, media latency, quality of service, and other factors.

As used herein, the term “virtual machine” means a software implemented abstraction of hardware, including one or more of processors, memory, modems, and so forth in any combination. An illustrative software implemented abstraction, in whole or in part, of an embedded client in a RTC-enabled digital device, is fully described herein.

As used herein, the term “virtual real time rich communications client” or virtual RTC client refers to a virtual machine in the cloud which executes one or more RTC components as a client. The software for a RTC component or components may be expressly written for a networked computer in the cloud, or it may be virtualized from applications embedded in a RTC-enabled digital device. The popular computer operating systems such as Windows, Linux, and so forth are virtualized on the cloud, and suitable virtualized machines which run these operating systems in the cloud are available from such companies as VMware, Inc. of Palo Alto, Calif., USA, and Rackspace US Inc. of San Antonio, Tex., USA. The process of taking a piece of software (client) that is written for an operating system on a device, to the virtual machines on the cloud is called “Virtualization,” and the resultant client running on the virtual machine may be referred to as a virtual client. The modules in the RTC architecture which are built and run on popular operating system platforms such as Windows, Linux, and Android, may be virtualized onto any of the virtual machines on the cloud, and may be referred to as the virtual RTC client. Preferably, there will be one instance of a virtual RTC client per RTC-enabled digital device. The various virtualization tools allow the creation and management of multiple instances of the virtual RTC clients when multiple RTC-enabled digital devices are using the RTC services in the system.

The RTC-enabled digital device may be provided with a web browser, which may be enabled for browser-based real time rich communications such as voice calling, video chat, texting, and P2P file sharing using WebRTC. WebRTC is defined by the World Wide Web Consortium (“W3C”); see, for example, GOOGLE INC. WebRTC General Overview [online], 2011-2012 [retrieved on 2013-05-21]. Retrieved from the Internet: <URL: http://www.webrtc.org/reference/architecture>. 3 pages. Advanced implementations have been done in the Chrome and Firefox browsers for PC and Mac desktop computers. See GOOGLE INC. WebRTC Demo [online], 2011-2012 [retrieved on 2013-05-21], retrieved from the Internet: <URL: http://www.webrtc.org/demo>, 1 page.

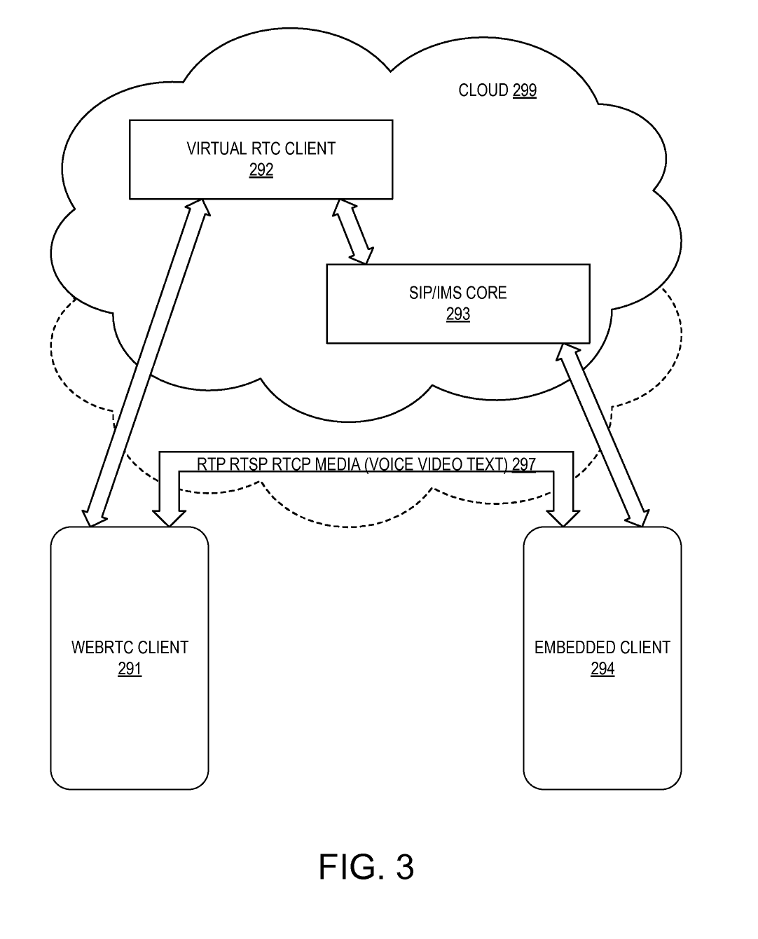

FIG. 3 shows an illustrative implementation of the signaling and media exchange plane functions among an RTC-enabled digital device operating as a WebRTC client 291 and a RTC-enabled digital device operating as an embedded client 294. Signaling between the WebRTC client 291 and the embedded client 294 is handled by the SIP/IMS core 293 on the cloud 299. The SIP/IMS core 293 (meaning either a SIP core or an IMS core) is a well-known architectural framework which operates as a server for delivering IP multimedia services, and may be anywhere on the cloud. The embedded client 294 may have all of the RTC components embedded therein, illustratively in the manner described in U.S. Pat. No. 8,639,253 issued Jan. 28, 2014 to Narayanan et al. and entitled “Real-Time Communications Client Architecture,” which hereby is incorporated herein in its entirety by reference thereto, and is therefore able to access the IP multimedia services available from the SIP/IMS core 293 in a client-server relationship over a signaling plane in the cloud 299. The WebRTC client 291 may have some RTC components embedded therein or may have none, with some or indeed all of the RTC components being embodied in a virtual RTC client 292 on the cloud. The WebRTC client 291 uses one or more APIs such as, for example, HTTP REST APIs, which enable communication with the one or more RTC components in the virtual RTC client 292 over a signaling plane, while the virtual RTC client 292 accesses the IP multimedia services available from the SIP/IMS core 293 in a client-server relationship over a signaling plane in the cloud 299. Using the signaling plane to set up the data transport, the WebRTC client 291 and the embedded client 294 may communicate RTP, RTSP, RTCP media (voice, video and text) 297 over a media exchange plane, which may be outside of the cloud or may pass through the cloud for transport (indicated by the dashed cloud portion in the figure), as desired

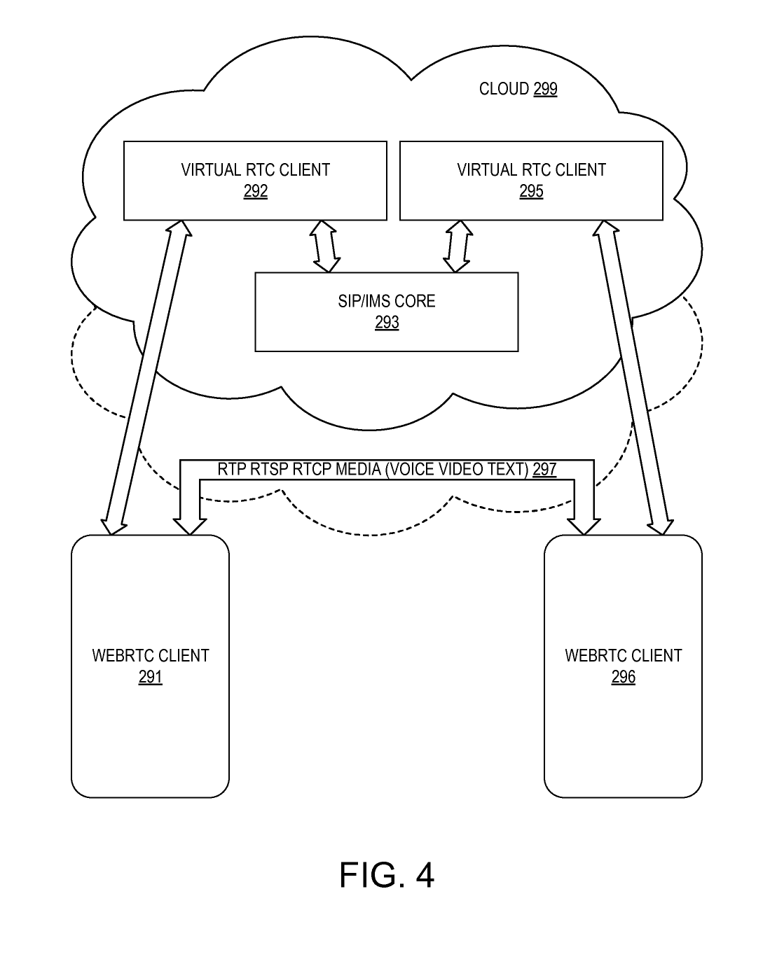

FIG. 4 shows an illustrative implementation of the signaling and media exchange plane functions among RTC-enabled digital devices operating as WebRTC clients 291 and 296. While only two WebRTC clients 291 and 296 are shown, more than two may communicate in the same manner. As in the FIG. 3 implementation, the WebRTC client 291 uses one or more APIs such as, for example, HTTP REST APIs, which enable communication with the one or more RTC components in the virtual RTC client 292 over a signaling plane, while the virtual RTC client 292 accesses the IP multimedia services available from the SIP/IMS core 293 in a client-server relationship over a signaling plane in the cloud 299. Similarly, the WebRTC client 296 uses one or more APIs such as, for example, HTTP REST APIs, which enable communication with the one or more RTC components in a virtual RTC client 295 over a signaling plane, while the virtual RTC client 295 accesses the IP multimedia services available from the SIP/IMS core 293 in a client-server relationship over a signaling plane in the cloud 299. Using the signaling plane to set up the data transport, the WebRTC clients 291 and 296 may communicate RTP, RTSP, RTCP media (voice, video and text) over a media exchange plane, which may be outside of the cloud or may pass through the cloud for transport (indicated by the dashed cloud portion in the figure), as desired.

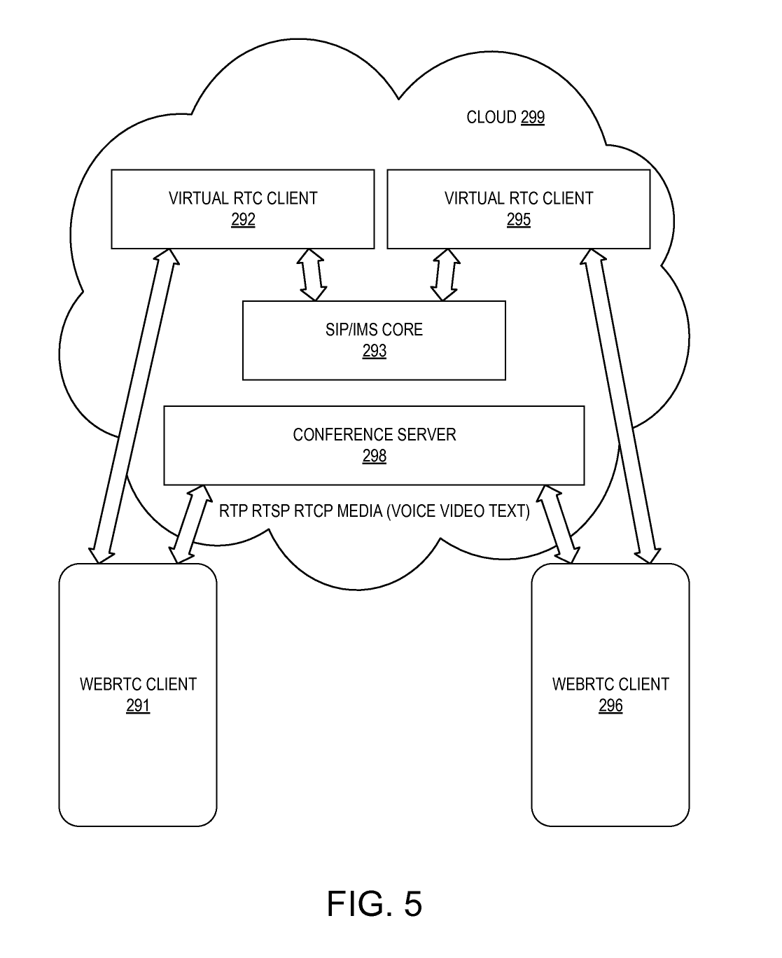

FIG. 5 shows an illustrative implementation of the signaling and media exchange plane functions among RTC-enabled digital devices operating as WebRTC clients 291 and 296. The signaling plane functions are as described for the FIG. 4 embodiment. However, the media exchange plane functions differ in that the data is not merely transported within the cloud, but is also processed in some desired manner using cloud resources. FIG. 5 shows the data being provided to, for example, a conference server 298 so that it may be shared among multiple conference participants. Another example of a cloud resource for data is a transcoding server, which may be used to convert data from one format to another for compatibility among multiple participants.

Many RTC components are needed in a typical RTC architecture. While these RTC components may be distributed among the RTC-enabled digital device and the virtual RTC client in any desired manner, the distribution may be facilitated by taking into account the service type of the RTC component, the RTC function of the RTC component, or both.

Consider distribution based on service type. The RTC-enabled digital devices vary in their characteristics in terms of CPU processor speed, available RAM/ROM for applications, and so forth. Based on the characteristics, some or all of the services (SIP/IMS, SMS, RCS, Voice, Video) may not be appropriate or even may not be possible to operate on the RTC-enabled digital device. For example, a low end mobile digital device may not have enough processing power to handle real time messaging, but may be able to handle simple text messages such as SMS. It may therefore be desirable to distribute the SMS service to the device, and RCS service to the virtual RTC client on the cloud. This mechanism is called distribution based on service types—SMS and RCS are various service types.

Consider distribution based on real time rich communication functions. In an RTC service, there are two types of functions: signaling and media exchange. Signaling refers to the steps involved in locating the recipient of the real time rich communication. For example, in a phone call, the called party is the recipient. There are many protocols used in signaling and one of the standards to make RTC functions is using SIP protocols. Typically, there are a number of signaling messages exchanged between the user and the network which offers the RTC service, to locate the recipient, invite for rich communication, establishing the common schemes of rich communication, and when both parties (caller and called) agree, the signaling for rich communication is established. This signaling happens once per communication, and hence generally does not have strict timing requirements.

Media Exchange refers to the steps involved after the signaling is established. It typically involves capturing media at the source, compress if necessary, encode if necessary, and transmit to the network for delivery to the recipient. Likewise, on the recipient side, media exchange steps involves receiving the media, decode if necessary, decompress if necessary, and playback or render the message. During a RTC session, there could be many media exchange operations so that the media packets arrive at the destination in time to have a good quality real time communication. Hence, the media exchange generally has strict timing requirements.

It may be desired to distribute media exchange components onto the device, and signaling components onto the cloud on the virtual RTC client. The media exchange functions such as hardware accelerated and media compression/encoding/decoding tend to be closely tied to the device characteristics, thereby justifying the distribution of media exchange components to the RTC-enabled digital device. The signaling components are usually done in software with protocol stacks and state machines that are suitable candidates for virtualization. Hence, the signaling components may be distributed to the cloud.

While the RTC components may be distributed exclusively among the RTC-enabled digital device and the cloud, one or more of the RTC components may be replicated in both the RTC-enabled digital device and the cloud. Using a policy control mechanism, the system may decide whether the RTC components in the device or the cloud to be used for an RTC service. This decision-making step may be done at the launch of the RTC service, at the device boot up, or at run time such as at call initiation or even during a call, based on load conditions in the cloud and device characteristics such as, for example, available CPU, RAM/ROM, and power resources and power consumption on the RTC-enabled digital device. For example, the RCS framework can be replicated on the RTC-enabled digital device and on the cloud. During launch of the service, the policy may indicate that RCS framework in the device to be used, whereupon the RCS framework on the cloud may be disabled. When RTC service provider network determines that the traffic on the cloud is fairly light, the policy may be changed to use the RCS framework on the cloud, whereupon the RCS framework on the device may be disabled. This allows greater flexibility to the RTC service providers to balance the load of computing and data processing resources on the RTC-enabled digital devices and the cloud to offer optimal RTC service.

Regardless of the distribution model, the RTC components in the RTC-enabled digital device and in the cloud may communicate using any of various suitable modes of communication. A particular popular mode of communication which is suitable is based on the use of TCP/IP sockets. Other suitable IP based rich communications modes for realizing the RTC service include UDP, HTTP, HTTPS, XMPP, and so forth.

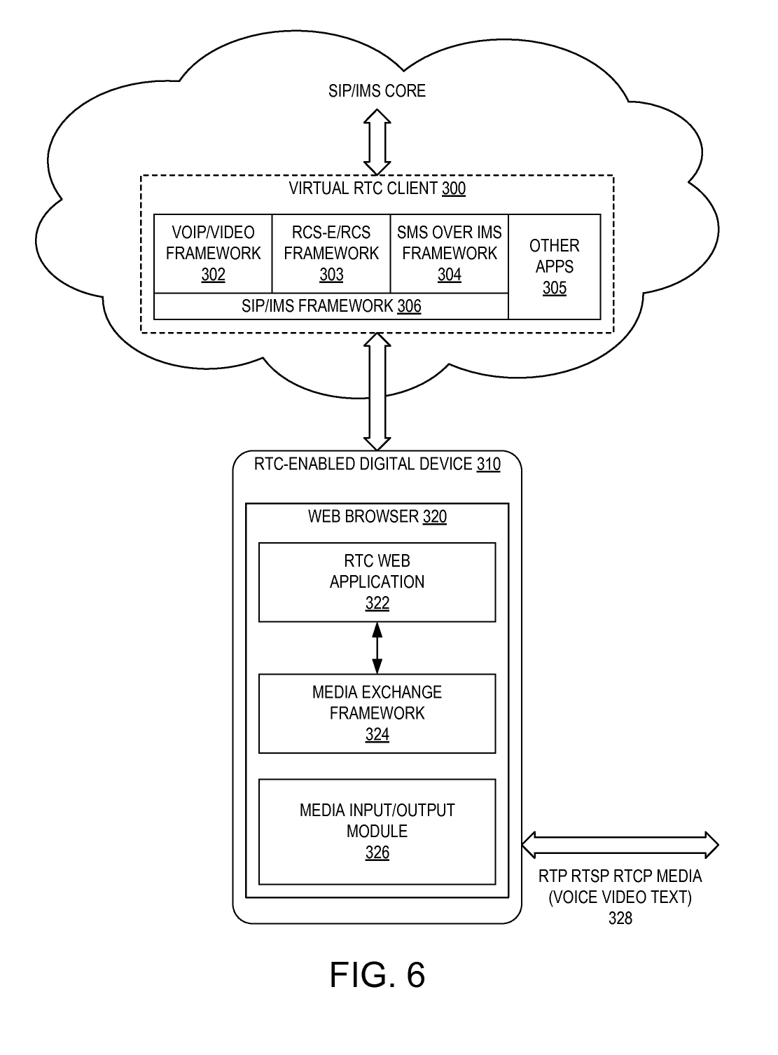

FIG. 6 shows an illustrative distribution of RTC components based on RTC function. In this distribution, all signaling functions for all RTC services, such as, for example, SMS over IMS, VOIP (of which VoLTE is a specific type), video, and RCS, are located in a virtual RTC client 300 on the cloud, while media exchange is supported on a RTC-enabled digital device 310. This distribution is particularly advantageous when the RTC-enabled digital device 310 has weak processing capability, limited software update capabilities, or poor power management.

Specifically, the RTC-enabled device 310 includes various modem services, codecs and media stacks (not shown), such as the 4G/LTE protocol stacks 210 shown in FIG. 2. The RTC-enabled digital device 310 also may include a web browser 320, which may be enabled for browser-based real time rich communication such as voice calling, video chat, texting, and P2P file sharing using, for example, the WebRTC API. The web browser 320 includes three components, namely a RTC web application 322, a media exchange framework 324, and a media input/output module 326. The virtual RTC client 300 located on the cloud includes a SIP/IMS framework 306, a VoIP/Video framework 302, a RCS-e/RCS framework 303, a SMS over IMS framework 304, and optionally other applications 305 such as, for example, various third party user applications (not shown). The media exchange framework 324 located in the RTC-enabled digital device 310 and the virtual RTC client 300 located on the cloud may communicate over a TCP/IP socket or by using any other suitable mode of communication.

The RTC web application 322 is a browser software module that contains the user Interface elements as well as the application logic and sequencing for carrying out the RTC services such as VOIP (including VoLTE), video calling, RCS and SMS. This application may be developed one per platform; for example, an Android device may have an Android-based application for RTC. The RTC web application 322 may be written in any suitable computer language such as, for example, the JavaScript programming language, and may be brought into the web browser 320 from the cloud in any manner desired by the device manufacturer, such as, for example, at power up, prior to each call, and so forth.

The media exchange framework 324 is a browser software module that contains algorithms for synchronizing audio and video for the video calling real time service, any specific assembling of media packets required by the RTC service providers, and buffering and adaptation techniques to compensate for varying network conditions. This framework is typically a platform-independent module; in other words, the same module may be used for various device platforms because the module is algorithm-based. This framework utilizes a platform-specific media input/output module (described below) using a well-defined APIs.

The media input/output module 326 is a browser software module that provides APIs to other modules such as, for example, the media exchange framework 324, to allow various basic functions. One illustrative basic function is media capture and playback: This module may interface with the hardware on the RTC-enabled digital device 310 to capture voice from microphone or video from a camera as the media input function. Likewise, this module may interface with hardware on the RTC-enabled digital device 310 to play audio thru speakers or headsets, or display video on the display. Another illustrative basic function is media encode and decode: This module may interface with the hardware on the RTC-enabled digital device 310 to encode raw media data using compression techniques typically used for RTC before transmission to a network. Likewise, when encoded media data is received from the network, this module may decode using decompression techniques. Codecs suitable for use in RTC include, for example, AMR for voice and H.264 for video. Another illustrative basic function is media transport and receive: This module may interfaces with the network stack on the RTC-enabled digital device 310 so that media data can be sent from the RTC-enabled digital device 310 to the network, and so that media data can be received from the network.

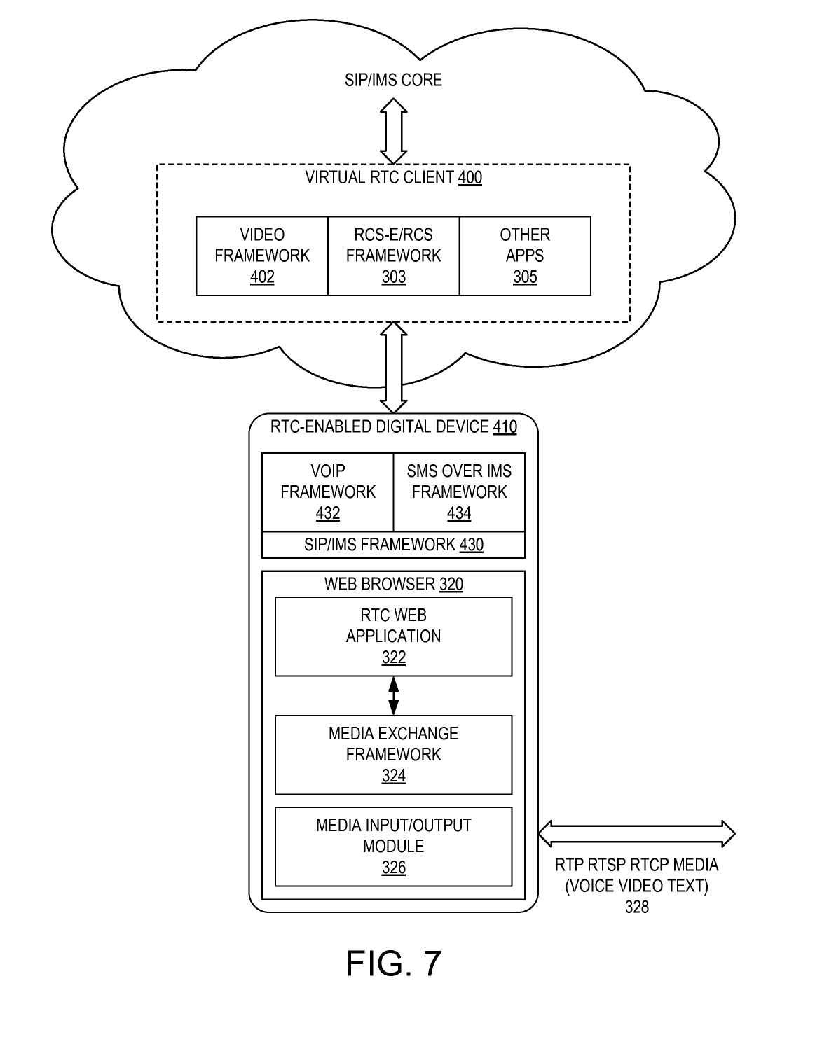

FIG. 7 shows an illustrative distribution of RTC components based on RTC service type. In this distribution, a RTC-enabled digital device 410 includes various modem services, codecs and media stacks (not shown) as well as the web browser 320 and its various applications, frameworks, and modules as described for the FIG. 6 distribution. However, the RTC-enabled digital device 410 may also include a SIP/IMS framework 430, a VoIP framework 432 (which may be VoLTE, for example), and a SMS over IMS framework 434. One may desire to distribute these frameworks to the RTC-enabled digital device 410 for any number of reasons, such as, for example, media latency and quality of service and is particularly suitable for devices where for a majority of the time the user uses SMS and voice calls, and only occasionally uses video or RCS services. These frameworks may be embedded in the device as delivered, either in ROM, programmable flash, or other type of non-volatile memory, and either in the platform, as part of the browser, or as part of an application. The virtual RTC client 400 located on the cloud includes a Video framework 402, the RCS-e/RCS framework 303, and optionally other applications 305 such as, for example, various third party user applications (not shown). The media exchange framework 324 located in the RTC-enabled digital device 410 and the virtual RTC client 400 located on the cloud may communicate over a TCP/IP socket or by using any other suitable mode of communication.

As will be appreciated from the attributes, advantages and disadvantages of the distributions of FIG. 6 and FIG. 7, many factors may be considered and balanced in deciding on the proper distribution of services for the particular type of chipset/SOC, purpose of the RTC-enabled digital device, capabilities of the cloud, and objectives of the service providers and the manufacturers and distributors of the RTC-enabled digital device and applications.

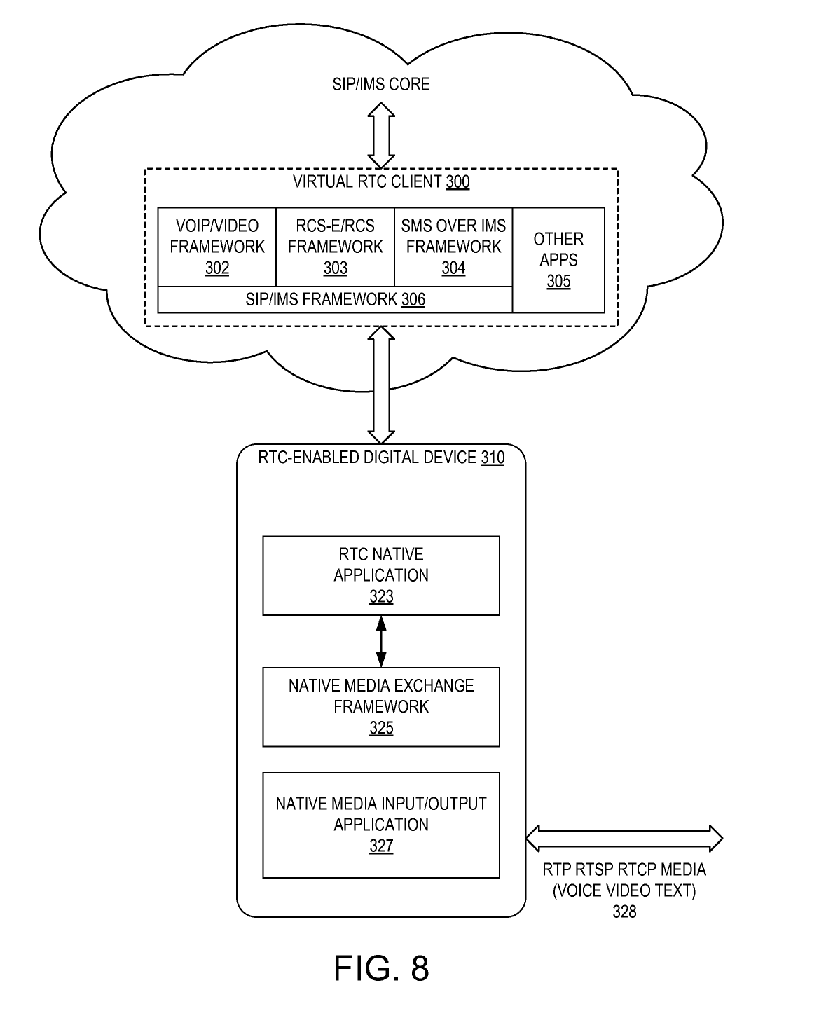

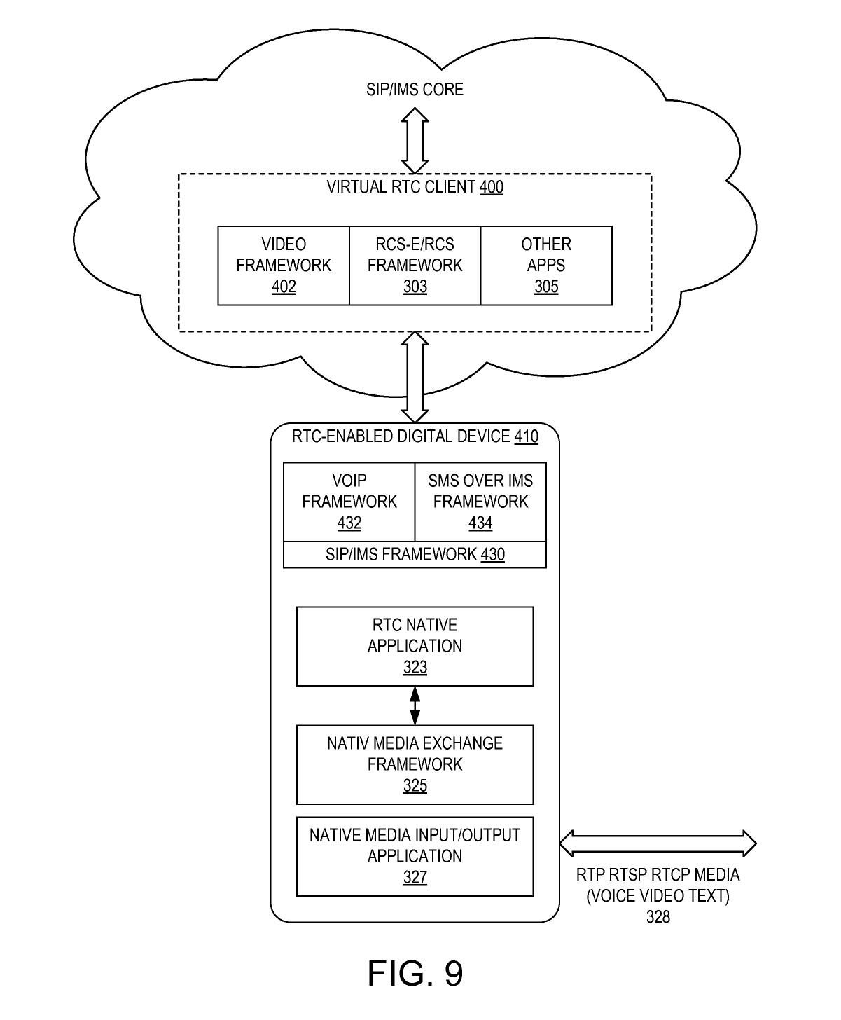

Although an RTC-enabled digital device may be provided with a web browser that is enabled for browser-based real time rich communications and may therefore participate in distributions of RTC components such as shown, for example, in FIG. 6 and FIG. 7, native applications may be used in RTC-enabled digital devices instead of or in accompaniment with web modules to achieve any desired distributions of RTC components. The distribution shown in FIG. 8 is the same as the distribution shown in FIG. 6, while the distribution shown in FIG. 9 is the same as the distribution shown in FIG. 7. However, the distributions shown in FIGS. 8 and 9 do not employ a RTC-enabled browser, but instead use a RTC native application 323 instead of the RTC web application 322, a native media exchange framework 325 instead of the media exchange framework 324, and a native media input/output application 327 instead of the media input/output module 326 to achieve the desired distributions.

The techniques described herein may in practice be combined in various ways to achieve various objectives. FIG. 3 shows the WebRTC client 291 being used for rich communications with the embedded client 294, while FIGS. 4 and 5 show multiple WebRTC clients 291 and 296 being used for rich communications with one another. In practice, users of many different types of RTC-enabled digital devices, which may or may not be WebRTC clients and may or may not include embedded components, are likely to desire rich communications with one another, and the techniques described herein may readily accommodate such needs. Two areas which are likely to experience substantial growth and in which RTC-enabled digital devices are expected to play a major role are tablets and the “Internet of Things” (“loT”).

The number of tablets in the market is growing rapidly and is replacing the traditional desktops, especially where mobility is highly desired. Most of these tablets connect to the internet through Wi-Fi, though some have LTE connections offered by mobile operators. Mobile operators who are launching VoLTE focus primarily on Smartphones and may not plan to offer the VoLTE services for users from these tablets. However, they would like to benefit from increasing the number of VoLTE calls made on their networks, not only among VoLTE Smartphones, but also between Smartphones and Tablets. In addition, Voice/Video traffic from tablets generally use Over-The-Top (OTT) communication services such as Skype, and terminate on Smartphones via legacy 3G gateways or via the OTT network. This mechanism does not take advantage of the quality offered by the VoLTE service. There is a need to enable tablets to participate in high quality voice/video calls with Smartphones without having to settle for low quality legacy voice/video calling services.

As the wireless networks become faster and more prevalent, the number of connected devices is expected to increase. There are many initiatives to address “Internet of Things” (loT) in the industry. The loT devices include things like connected cars, game consoles, utility meters, healthcare equipment and home appliances, in addition to the conventional devices such as personal computers, tablets and smartphones. There is a need to connect these loT devices with VoLTE Smartphones for seamless communications and messaging experience. These loT devices usually follow light-weight data transfer protocols such as MQTT or XMPP, so that the CPU power and battery consumption in these devices may be kept low and optimal for their use. This results in the need for gateways and associated software to convert these loT protocols to VoLTE protocols to enable communications and messaging among loT devices and VoLTE devices.

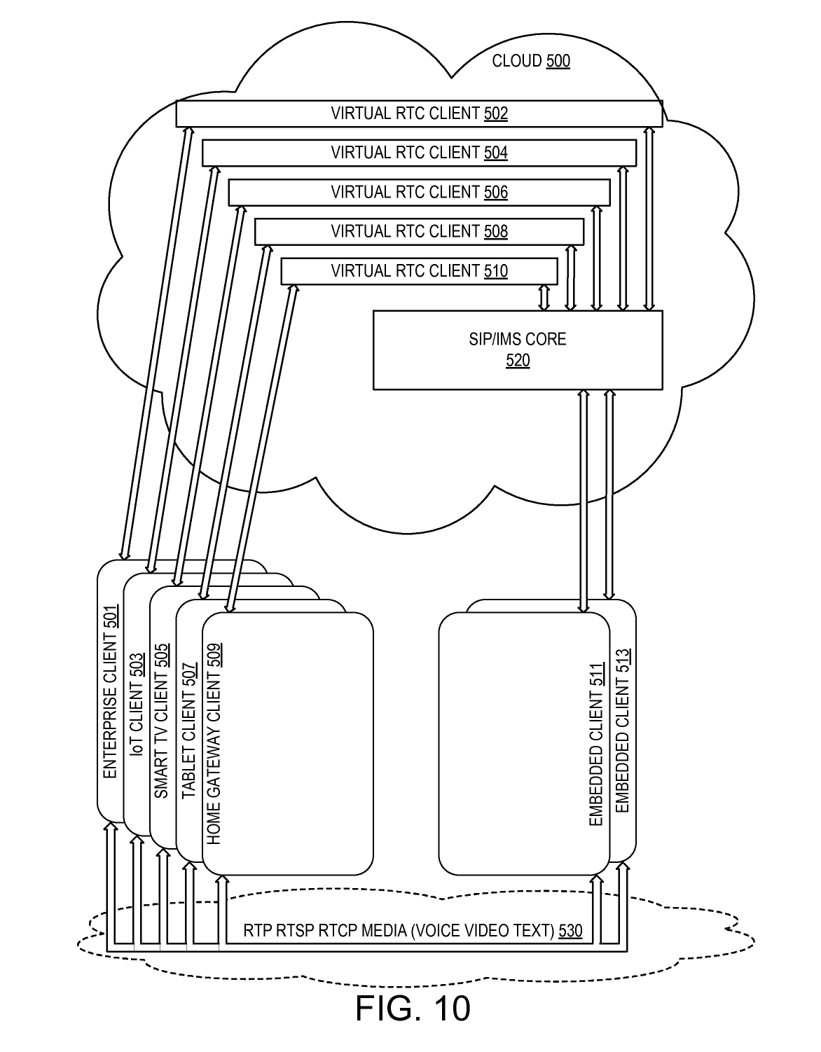

FIG. 10 is a schematic block diagram of an illustrative implementation of the signaling and media exchange plane functions among multiple RTC-enabled digital devices, which aggregates various of the techniques described above into a system of RTC-enabled digital devices which are fully capable of rich communications with one another. The clients for several types of RTC-enabled digital devices are shown, namely an enterprise client 501, a loT client 503, a smart TV client 505, a tablet client 507, and a home gateway or router client 509. Embedded clients 511 and 513 for two other RTC-enabled digital devices are also shown. Each of these clients may support rich communications with other RTC-enabled digital devices of the same type, other RTC-enabled digital devices of different types, and other RTC-enabled digital devices operating with embedded clients. These RTC-enabled digital devices may include native applications and/or browser-based web applications, the latter usually being served by a web server (not shown) as is well known in the art. These RTC-enabled digital devices may or may not include web browsers. The enterprise client 501, the loT client 503, the smart TV client 505, the tablet client 507, and the home gateway or router client 509 are virtualized onto any of the virtual machines on the cloud, where they may be referred to as virtual RTC clients 502, 504, 506, 508 and 510 respectively. Preferably, there will be one instance of a virtual RTC client per RTC-enabled digital device, and the various virtualization tools allow the creation and management of multiple instances of the virtual RTC clients when multiple RTC-enabled digital devices are using the RTC services in the system. Signaling between the RTC-enabled digital device of one of types mentioned above and its corresponding virtual RTC client is handled using HTTP REST APIs, XMPP, MQTT or similar light-weight signaling protocols as desired. The virtual RTC client on the cloud translates these light-weight protocols to SIP/IMS protocols that are handled between the virtual RTC client and the SIP/IMS core 520. The media exchanges 530 between RTC-enabled digital devices are done either directly or with the help of a media gateway (not shown).

The VoLTE standard specifies SIP/IMS as the protocols of choice for signaling and RTP/RTCP for media exchange and control. In addition, VoLTE and Video Calling standards specify AMR/AMR-WB for voice codecs and H.264 for the video codec. The WebRTC standard leaves the signaling mechanism to the implementer's choice, including the SIP/IMS protocol, and supports RTP for media exchange and control. However, WebRTC specifies Opus for voice codec and VP8 for video codec. To enable media exchange among VoLTE and WebRTC clients, any of various techniques are suitable, including, for example, (a) using a media gateway to transcode voice and video media packets; (b) including WebRTC codecs in the VoLTE clients or in the RTC-enable digital device; or (c) including VoLTE codecs in the WebRTC clients or in the RTC-enabled digital device. While the media gateway technique may allow increased media latency and hence degraded voice/video quality and may also increase the cost of the gateway equipment advantageously the clients are kept strictly compliant with the standards. Including WebRTC codecs in VoLTE clients advantageously eliminates the need for a media gateway, although such a VoLTE client may not be strictly compliant with the standards. Including VoLTE codecs in WebRTC client advantageously eliminates the need for media gateway, although such a WebRTC client may not be strictly compliant with WebRTC standards. Since the WebRTC client is usually a web application running inside the web browser, the VoLTE codecs are done in the web browser and would involve the participation of the web browser vendors. Advantageously, a stand-alone WebRTC client which runs without a web browser may be employed to achieve the same result. The mobile operators, handset maker and enterprise service providers may weigh the pros and cons of these options to select the most appropriate media exchange mechanisms for their purposes.

The RTC-enabled digital device may be implemented with function calls or with a Services and Application Controller (“SAC”) as described in U.S. Pat. No. 8,639,253 issued Jan. 28, 2014 to Narayanan et al. and entitled “Real-Time Communications Client Architecture,” which hereby is incorporated herein in its entirety by reference thereto. Several SAC implementations are described in U.S. Pat. No. 8,613,002 issued Dec. 17, 2013 to Narayanan et al. and entitled “System, Method and Apparatus for Controlling Multiple Applications and Services on a Digital Electronic Device,” which hereby is incorporated herein in its entirety by reference thereto.

Utilizing the cloud infrastructure for RTC functions has many advantages relative to real time operating systems (“RTOS”) running on the modem processor and general purpose operating systems (“GPOS”) running on the application processor of an embedded client. Security is high, relative to low security of the embedded client—RTOS security is high but GPOS security is low. Control offered to service providers is high, relative to low control offered by the RTOS and GPOS of the embedded client. Scalability is high, relative to low scalability of both the RTOS and GPOS of the embedded client. The services which may be offered by the cloud are at least equivalent to the services which may be offered by the GPOS of the embedded client.

The various embodiments of the invention described herein are illustrative of our invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention, as set forth in the following claims.

1. A real-time rich communications (“RTC”) client architecture for rich communication services, comprising:
a virtual real time communications client (“virtual RTC client”) on the cloud; and
a real time rich communications enabled digital device (“RTC-enabled digital device”) comprising at least one processor and digital memory, and further comprising software components stored in the digital memory and executable by the processor to enable real time signaling via the virtual RTC client.

2. The real-time rich communications client architecture of claim 1, further comprising:
a Session Initiation Protocol/Internet Protocol Multimedia Subsystem (“SIP/IMS”) core on the cloud configured to operate as a server for delivery of IP multimedia services;
wherein the virtual RTC client is configured to access the IP multimedia services from the SIP/IMS core in a client-server relationship.

3. The real-time communications client architecture of claim 1, wherein the software components stored in the digital memory are further executable by the processor to establish and maintain real time media transport.

4. The real-time rich communications client architecture of claim 3, further comprising:
a media gateway;
wherein the software components stored in the digital memory are further executable by the processor to establish and maintain real time media transport through the media gateway.

5. The real-time rich communications client architecture of claim 3, further comprising:
a Web Real-Time rich Communications (“WebRTC”) codec;
wherein the software components stored in the digital memory are further executable by the processor to establish and maintain real time media transport with the WebRTC codec.

6. The real-time communications client architecture of claim 3, wherein the real time media transport comprises real time web browser-based media transport.

7. The real-time rich communications client architecture of claim 3, further comprising:
a Voice over Long Term Evolution (“VoLTE”) codec;
wherein the software components stored in the digital memory are further executable by the processor to establish and maintain real time media transport with the VoLTE codec.

8. The real-time rich communications client architecture of claim 7, further comprising:
a web browser installed on the RTC-enabled digital device;
wherein the web browser comprises the VoLTE codec.

9. The real-time communications client architecture of claim 1, further comprising a plurality of modular frameworks for rich communications services, the modular frameworks being distributed among the virtual RTC client and the RTC-enabled digital device with the virtual RTC client comprising from one to all of the modular frameworks installed thereon, and the RTC-enabled digital device comprising from none to all of the modular frameworks installed thereon.

10. The real-time communications client architecture of claim 9, wherein the distribution is exclusive among the RTC-enabled digital device and the virtual RTC client.

11. The real-time communications client architecture of claim 9, wherein at least one of the modular frameworks in the distribution is replicated in the RTC-enabled digital device and the virtual RTC client.

12. The real-time communications client architecture of claim 9, wherein the modular frameworks comprises a modular Session Initiation Protocol/Internet Protocol Multimedia Subsystem (“SIP/IMS”) framework, a modular Voice over Internet Protocol (“VoIP”) framework, a modular video framework, a modular Rich Communications Services (“RCS”) framework, and a modular Short Message Service (“SMS”) framework.

13. The real-time communications client architecture of claim 12, wherein the modular SIP/IMS framework, the modular VoIP framework, the modular video framework, the modular RCS framework, and the modular SMS framework are installed on the virtual RTC client.

14. The real-time communications client architecture of claim 12, wherein:
the modular SIP/IMS framework, the modular VoIP framework, and the modular SMS framework are installed on the RTC-enabled digital device; and
the modular video framework and the modular RCS framework are installed on the virtual RTC client.

15. A service running in the cloud comprising a virtual real time rich communications client (“virtual RTC client”) configured to communicate with a real time rich communications enabled digital device and with a Session Initiation Protocol / Internet Protocol Multimedia Subsystem (“SIP/IMS”) core in a client-server relationship on the cloud to enable real time rich communication services.

16. The service of claim 15 wherein the virtual RTC client comprises one or more of a modular Session Initiation Protocol/Internet Protocol Multimedia Subsystem (“SIP/IMS”) framework, a modular Voice over Internet Protocol (“VoIP”) framework, a modular video framework, a modular Rich Communications Services (“RCS”) framework, and a modular Short Message Service (“SMS”) framework.

17. A method for providing real-time rich communications over the cloud, comprising establishing communication between a virtual real time communications client (“virtual RTC client”) on the cloud and a RTC-enabled digital device, the RTC-enabled digital device comprising at least one processor and digital memory, and further comprising software components stored in the digital memory and executable by the processor to enable real time signaling via the virtual RTC client.

18. The method of claim 17 wherein the establishing step further comprises establishing a signaling plane between the virtual RTC client and a Session Initiation Protocol/Internet Protocol Multimedia Subsystem (“SIP/IMS”) core on the cloud, the virtual RTC client being configured to access IP multimedia services from the SIP/IMS core in a client-server relationship.

19. The method of claim 17 further comprising establishing a media transport plane with the RTC-enabled digital device, the software components stored in the digital memory being further executable by the processor to establish and maintain real time media transport.

20. The method of claim 17 wherein the real-time rich communications over the cloud are enabled by a plurality of modular frameworks for rich communications services, including a modular framework for signaling, the modular frameworks being distributed among the virtual RTC client and the RTC-enabled digital device with the virtual RTC client comprising from one to all of the modular frameworks installed thereon, and the RTC-enabled digital device comprising from none to all of the modular frameworks installed thereon.

21. A method comprising to enable real time rich communication services:
communicating between a virtual real time rich communications client (“virtual RTC client”) and a real time rich communications enabled digital device; and
communicating between the virtual RTC client and a Session Initiation Protocol / Internet Protocol Multimedia Subsystem (“SIP/IMS”) core in a client-server relationship on the cloud.
